(19) United States
(12) Patent Application Publication
(10) Pub. No.: US 2011/0112937 A1
(43) Pub. Date: May 12, 2011

(54) iMotorZ

(76) Inventors: Robert M. Schorrbusch, Jackson, NJ (US); Michael S. Maibach, Jackson, NJ (US)

(21) Appl. No.: 12/617,139

(22) Filed: Nov. 12, 2009

(51) Int. Cl. G06Q 99/00; G06Q 30/00

(52) U.S. Cl. 705/27.2; 705/26.5

(57) ABSTRACT

iMotorZ is a virtual reality hobby and environment in which the user obtains access to and ownership of a virtual vehicle to which the user can make modifications and customizations analogous to how a car collector or enthusiast may choose to modify and maintain a real car. The novelty is that the user of the virtual car does not need the space or financial resources that a real car would require. The user purchases a small-scale model of the desired vehicle, and then registers online using a unique identification number that comes with the retail model. Registration provides access to a variety of web-based databases, games and forums through which the user may customize the virtual vehicle, and obtain and share information about the virtual vehicle, thereby creating a unique history of the virtual vehicle.

### CROSS-REFERENCE TO RELATED INTENTIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE TO MATERIAL SUBMITTED ON A COMPACT DISC

Not Applicable

### BACKGROUND OF THE INVENTION

Field of Search (Ganz) 446/175,470 463/42

The invention pertains to a utility classification involving computer-based virtual vehicles which may be customized, collected, and/or traded among motorized vehicle enthusiasts and hobbyists, henceforth referred to as “hobbyists” or “users”, using dedicated online resources found within static and dynamic databases.

Today more than ever it can be difficult to find the time or financial resources to enjoy an otherwise expensive hobby such as classic car collecting and/or restoration, but with iMotorZ, and its component web-based portal to a myriad of databases, participation in such a hobby can be effected in a virtual reality world that allows the hobbyists and collectors to interact with other iMotorZ users. The virtual vehicles may be customized using resources available to the hobbyists through various dedicated databases including parts and supplies stores, technical information databases, virtual retail value guides, and social groups which allow users to exchange information, advice and suggestions. Interactive games can be created which allow hobbyists to earn iMotorZ virtual dollars that can be spent on parts to customize the virtual vehicle. A participant's virtual vehicle may take on a virtual value for sale or trade within the community of collectors and users. While some of the databases may be comprised of static information, others may be dynamic and interactive, reflecting the increasing incorporation of user input. Furthermore, the customization of the virtual vehicle may serve as a plan for customizing a real-life version of the vehicle when the user's resources permit.

### BRIEF SUMMARY OF THE INVENTION

The invention called iMotorZ is a web-based hobbyist utility primarily consisting of unique virtual motorized customizable vehicles, also individually called iMotorZ, analogous to actual real-life, full-scale stock factory models of various motorized vehicles. Dedicated static and dynamic databases and users' social forums provide the resources necessary for a hobbyist to customize his or her virtual vehicle as an individual and unique creation of that user. The hobbyist obtains the virtual vehicle by purchasing a real, small-scale three-dimensional model, henceforth referred to as the “model”, of an actual motorized vehicle. The model is a manufactured representation of an actual factory stock vehicle.

The models may be in a variety of scales and materials. These models include inexpensive toy-like models as well as higher quality, potentially collectible, vehicles. Also generally called iMotorZ, these models are based on real-life motorized vehicles including, but not limited to, cars, trucks, SUVs, motorcycles, trains, planes, heavy construction equipment, and even space shuttle-like vehicles and other rocket ships. Each real-life iMotorZ model thus represents the iMotorZ virtual analogue of a real factory stock or standard motorized vehicle. The real-life model is retailed with a unique vehicle identification number, henceforth called the “VIN” or “VIN number” that, upon registration with the iMotorZ portal, provides access to the corresponding virtual vehicle.

Once the user registers the VIN number and is assigned a unique virtual vehicle, the portal then provides access to the various databases such as virtual parts stores, virtual services, technical data and assistance, valuation databases, games, social and marketing forums. It is the iMotorZ virtual vehicle that is the primary object being acquired by the hobbyist, and is the object of interest and activities including the customizations that the user is interested in making to the iMotorZ virtual vehicle.

### BRIEF DESCRIPTION OF DRAWINGS

We believe drawings of motorized vehicles with numbers attached are not necessary to understand and envision the invention.

### DETAILED DESCRIPTION OF THE INVENTION

The invention called iMotorZ consists of three essential and integral components:

The small-scale, real-life, iMotorZ model vehicle that represents a real world analogue of the model vehicle, with an integral and unique vehicle identification number, or VIN. The iMotorZ model and unique VIN number is exclusively acquired by the hobbyist through the retail purchase of the model. When the user registers with the iMotorZ website, the VIN provides access through an iMotorz web portal to exclusive online databases, games and resources;

The iMotorZ virtual-reality vehicle analogue of the retail model vehicle, both of which correspond to a real-life factory stock vehicle. These vehicles may be cars, SUVs, trucks, motorcycles, heavy construction equipment, trains, planes and rockets. The iMotorZ virtual vehicles are novel in that they will develop an exclusively unique history of modifications, maintenance, and ownership subject only to the choices and actions of the owner user; and

A web-based portal with associated databases, games and resources which contain information including manufacturers' specifications of the real-world analogue vehicles, as well as historical records pertaining to routine maintenance and customizations related to the specific virtual vehicle represented by the real-life retail model. The portal also provides access to games, virtual stores, and virtual services related to maintenance and customizations of said iMotorZ virtual vehicles. The portal will also provide set up space for, and access to, interactive forums for the hobbyists including clubs based on the car make and model, chat rooms, resale and trade markets, etc. Thus, the databases will consist of both iMotorZ pre-designed static databases, as well as dynamic databases that evolve based on users' interests, choices and input.

The utility of the invention is to provide certain hobbyists who desire to modify, restore and collect motorized vehicles, but may not have the finances or the space for such a hobby, with a virtual forum in which the hobbyist can customize these virtual vehicles according to their interests.

The real-world retail iMotorZ vehicle models, may be manufactured in a variety of different scales and materials, including small-scaled metal and/or plastic cars similar to Hot Wheels™ cars, SUVs and trucks, or Lionel™ trains. The models may be simply designed or more expensive intricately designed pre-assembled vehicles. Further, the models may be of a type that requires skillful assembly, thus adding another hobby dimension to the invention for the hobbyist.

The process of using iMotorZ begins with the retail purchase of the real-life iMotorZ model vehicle. Each and every said model vehicle will come with a unique vehicle identification number, or VIN, assigned and recorded by the iMotorZ manufacturer and attached to the model either permanently, or less so. For example, the VIN number may be stamped or molded onto the model, or a sticker may be affixed to the model or the original packaging. The user will be prompted to register the VIN number obtained with the model online at the iMotorZ website. The VIN number may only be registered once at the iMotorZ portal. At said website the VIN number will allow the owner to create a user identification (or login name) and a password. With the login name and password, the user would virtually obtain the original edition of the iMotorZ virtual vehicle, and gain access to the iMotorZ web portal. The portal in turn provides access to the databases, games and forums that are the venues for activities the user will engage in involving that person's iMotorZ virtual vehicle. The unique VIN number is associated exclusively and permanently with the corresponding unique iMotorZ virtual vehicle, even in the event of change of ownership.

The virtual vehicle is ultimately the object of the hobbyist's efforts and activities including customizations. Such customizations include cosmetic changes such as paint jobs, additions of spoilers, hood scoops, and other accessories. Other customizations include mechanical modifications including such things as engine changes and modifications, changes to suspension, and other such changes. However the virtual vehicle is customized, transformed or exchanged, the original VIN number remains with that vehicle throughout all transformations. Thus, the virtual vehicle that is customized, transformed or sold will be acquiring a continuous history that can be tracked by a user database similar to CarFax™ but with more comprehensive details.

Thus, the databases include imitations, at least, of real databases that exist for real vehicles, including such common databases as the Kelly Blue Book which gives current market values of different automobiles based on make, model, year and condition, and Consumer Reports which rates quality, value and consumer satisfaction with given vehicle makes and models. Some databases are more dynamic, such as one detailing the maintenance history of the virtual vehicle, and may be constructed through the user's input over time. Other sites will provide accessories, parts and services to be used by the owner of the virtual vehicle to customize and transform said vehicle according to the users desires. Ownership of and title to virtual vehicle may be transferred or sold through the exchange of virtual iMotorZ money and/or other iMotorZ virtual vehicles. However, the original VIN number is exclusively assigned to a given virtual vehicle and remains permanently assigned to that specific iMotorZ vehicle. In any case, the hobbyist, through the choices he or she makes with a specific iMotorZ virtual vehicle, will create a one-of-kind storyline and historical record for the life of the virtual vehicle.

### DRAWINGS

We believe drawings of motorized vehicles with numbers attached are not necessary to understand and envision the invention.

1. We claim the concept of creating a virtual community on the web in which individual users can obtain and collect various iMotorZ virtual motorized vehicles, represented by purchased real-life models of said vehicles, which include but are not limited to transportation and work vehicles, and with which said users can access online resources, including games and specialized databases to be used in customizing, trading and selling said virtual vehicles, join online car clubs and social forums, and create and use other relevant iMotorZ resources and forums specific to iMotorZ virtual vehicles. Ownership of said virtual vehicles is established by the purchase and online registration of real-life models, each of which comes with a unique VIN number.

2. We claim the creation and use of the virtual vehicle and databases as in claim 1 that will work with the specific virtual vehicle through registration of a unique vehicle identification number, “VIN”, obtained through the purchase of a corresponding small-scale, real-life model which comes with the unique VIN number. This includes the establishment and ownership of a registry of the unique vehicle identification numbers, VIN numbers, which will be assigned permanently by the manufacturer to a given virtual vehicle. The user registers the purchased real-life model's VIN at the iMotorZ website which in turn acts as a portal that provides exclusive access to the virtual vehicle and the databases and forums with which the user and the virtual vehicle can interact. Such databases may include static databases for such vehicles such as new and used car values, which depend on criteria such as make, model, age, and condition of a given vehicle. Other databases may be more interactive and evolutionary as said users contribute input to, and create, an online history of a given virtual vehicle just as would occur over the life span of a real-life vehicle. Finally, iMotorZ users can access game sites designed to reward users with virtual money to use in obtaining parts and services.

3. We claim the manufacture and unique, exclusive identification through said VIN number, of the real-life models of said virtual vehicles that are sold and distributed exclusively by iMotorZ and its authorized distributors. Once registered online with the exclusive iMotorZ registry as perscribed, the user is entitled to access the online databases containing information about the vehicle's value, specifications, service charges, etc., as well as interactive databases and forums to be used as described previously. The VIN number would ideally be permanently stamped on the model when purchased, but may be attached to the packaging as a label with the VIN number, and possibly a bar code that may also be uniquely correlated to each vehicle regardless of ownership transfer. Such models may be made in a variety of ways. Some of these models may be constructed as soft plush toys for younger children, similar to WebKinz™ figures. Increasingly sophisticated and engineered models of plastic and/or metal would also be marketed. These models may range from relatively inexpensive HO scale cars and trains, to intricately designed higher valued real-life models that are collectable in their own right, apart from their correspondence to a virtual vehicle.
